(19) United States
(12) Patent Application Publication
(10) Pub. No.: US 2007/0107602 A1
(43) Pub. Date: May 17, 2007

(54) Wine cellar insulation system

(75) Inventors: Lee Zinser, Brooklyn, NY (US); Robert Rodish, Patterson, NY (US)

Correspondence Address: LEE ZINSER, 189 AMITY ST., BROOKLYN, NY, 11201, US

(73) Assignee: CONSOLIDATED CELLARS, LLC, Patterson, NY (US)

(21) Appl. No.: 11/164,288

(22) Filed: Nov. 17, 2005

(51) Int. Cl. A23L 1/00

(52) U.S. Cl. 99/275

(57) ABSTRACT

A wine cellar insulation system for the enhancement and control of the wine cellar and wine storage environment.

### BACKGROUND

A wine cellar is a temperature and humidity controlled environment. This is necessary to allow for proper storage of wines which allows for appropriate aging. Most important for the protection and proper aging of wines is correct and constant temperature, correct and constant relative humidity, the absence of vibration, the absence of mold and mold spores, sound absorption, and structural strength of the wine cellar construction.

Because wine cellars are a different climate to surrounding areas of the adjacent living spaces, there is positive air and moisture pressure from outside the wine cellar inward. This often creates condensation, a build up of moisture, temperature fluctuations, heat transfer, and favorable living and breeding conditions for mold. Another problem rarely addressed is the problem of minute vibration from mechanical or other external sources. This vibration adds unwanted energy to the stored wines preventing proper storage conditions.

There are many types of insulations and vapor barriers. Because of the lack of understanding in what is needed in a wine cellar, products that are inappropriate or only address one or two of the many issues needing attention for a wine cellar are used. Many products will actually contribute to long term wine cellar problems by retaining and allowing the accumulation of moisture and not addressing appropriately the inherent problems. When problems arise in a wine cellar it is very rare that the problem can be rectified without major renovations. Our complete wine cellar insulation system was invented and designed to address all well known and lesser know problems that are associated specifically with wine cellars both long term and short term.

### SUMMARY

Proper wine storage is necessary for the proper aging of wines. Environmental control and consistency is paramount in the proper storage of wines. Mold is a huge problem since it grows and lives in a similar environment as is necessary for proper storage of wines. Vibration and sound control are also very important in the stability of wine and preservation of the wine cellar itself. Our insulation system creates an isolation barrier between two environments which allows the control of temperature, humidity, vibration, sound, and mold growth. Our system does not allow for the retention of moisture or the penetration of heat transfer. It works in conjunction with accepted construction practices and applications. It is flexible enough to address concerns that are prevalent on a case by case basis thus addressing potential problems appropriately.

### DESCRIPTION OF PRODUCT APPLICATION

The wine cellar insulation system is applied and installed in a combination of the following fashions as each project dictates, (a) installed in the cavities of walls, ceilings, and floors (b) applied to the interior of walls, ceilings, and floors, (c) applied to exterior of walls, ceilings, and floors. The said applications create a complete environmental envelope and isolation package from surrounding living spaces.

### DETAILED DESCRIPTION

The wine cellar insulation system is comprised of the following components, (a) Diphenylmethane Diisocynanate (MDI), (b) Higher Oligomers of Diphenylmethane Diisocynanate, (c) Intrumescent Acrylic Polymers, (d) Thixotropic Acrylic Polymers, (e) Catalytic Biochemcial.Proteins, (f) Catalyzed Silicate Compounds

What is claimed is:

1. A wine cellar insulation system which comprises in combination, (a) of a component that prevents heat transfer, (b) of a component that creates maximum insulation value, (c) of a component that prevents vapor migration, (d) of a component that absorbs vibration, (e) of a component that prevents the growth of mold, (f) of a component that treats concrete to prevent moisture migration, (g) of a component that adds structural strength to cellar construction, (h) of a component that absorbs sound.

2. An insulation system that is installed in the wine cellar or wine storage facility for the benefits described in claim #1. This wine cellar insulation system is installed in, (a) walls, (b) floors, (d) ceilings, (e) and all exterior parameters of the wine cellar to maintain and enhance wine cellar environmental control.
